(19) United States
(12) Patent Application Publication
(10) Pub. No.: US 2010/0287565 A1
(43) Pub. Date: Nov. 11, 2010

(54) METHOD FOR MANAGING REQUESTS ASSOCIATED WITH A MESSAGE DESTINATION

(75) Inventors: JASON C. EDMEADES, EASTLEIGH (GB); AVINASH GUPTA KONDA, BANGALORE (IN); PHILIP G. WILLOUGHBY, EASTLEIGH (GB)

Correspondence Address: LAW OFFICE OF JIM BOICE, 3839 BEE CAVE ROAD, SUITE 201, WEST LAKE HILLS, TX, 78746, US

(73) Assignee: INTERNATIONAL BUSINESS MACHINES CORPORATION, ARMONK, NY (US)

(21) Appl. No.: 12/774,827

(22) Filed: May 6, 2010

(30) Foreign Application Priority Data
May 11, 2009 (EP) 09159838.3

(51) Int. Cl. G06F 9/46

(52) U.S. Cl. 719/314

(57) ABSTRACT

A method, apparatus and/or computer program product manage a request for a message destination. A request to create a new temporary destination at a receiving computer is intercepted, and generation of the new temporary destination is suppressed. A pre-defined destination that is operable to store the message instead of the new temporary destination is selected. An identifier, which is assigned to the new temporary destination, is associated with the pre-defined destination.

### BACKGROUND

The present invention relates to a method, apparatus or software for managing requests associated with a destination (e.g., a queue in a messaging system).

### BRIEF SUMMARY

A method, apparatus and/or computer program product manage a request for a message destination. A request to create a new temporary destination at a receiving computer is intercepted, and generation of the new temporary destination is suppressed. A pre-defined destination that is operable to store the message instead of the new temporary destination is selected. An identifier, which is assigned to the new temporary destination, is associated with the pre-defined destination.

### BRIEF DESCRIPTION OF THE SEVERAL VIEWS OF THE DRAWINGS

FIG. 1 is a schematic illustration of a computer system comprising a messaging system;

FIG. 2 is a schematic illustration of elements of a message queue manager application program in the messaging system of FIG. 1;

FIG. 3 is a flow chart illustrating the processing performed in response to receiving a request to create a temporary queue;

FIG. 4 is a flow chart illustrating the processing performed in response to receiving a request to put a message on a temporary queue;

FIG. 5 is a flow chart illustrating the processing performed in response to receiving a request to browse a temporary queue or get a message from a temporary queue; and

FIG. 6 is a flow chart illustrating the processing performed in response to receiving a request to delete a temporary queue.

### DETAILED DESCRIPTION

A computer system can comprise application programs that intercommunicate using messaging. Such messaging is managed by a messaging application program. Messages are communicated asynchronously between application programs using destinations, e.g., message queues. An application program can store (also known as “put”) messages on a queue and also retrieve (also known as “get”) messages from a queue.

Queues commonly have a defined function, that is, a given queue is used for communicating between a specific set of application programs or for communicating messages of a particular type.

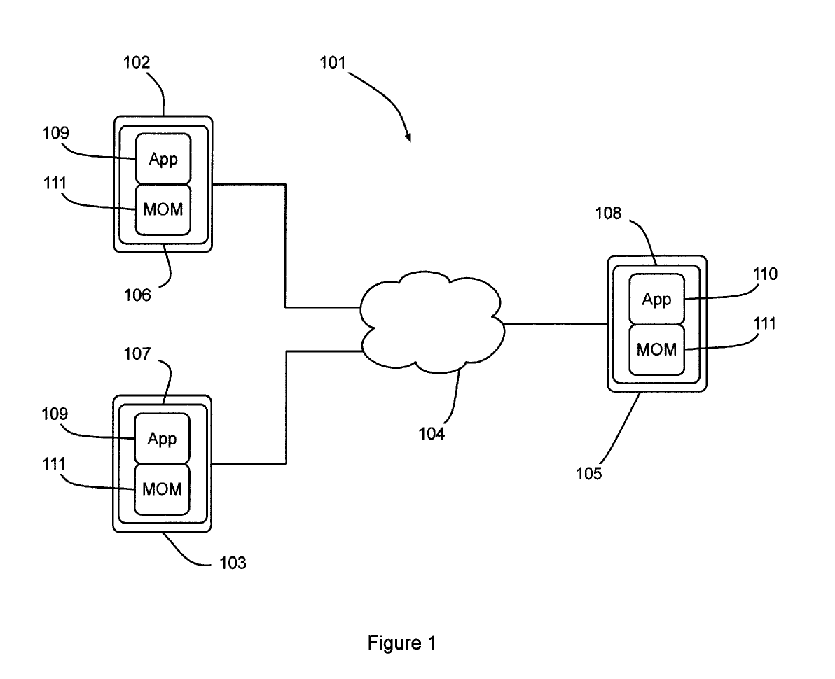

With reference now to the figures, and in particular to FIG. 1, a computer system 101 comprises two client computers 102, 103 connected using a network 104 to a server computer 105. Each of the computers 102, 103, 105 is loaded with a respective operating system 106, 107, 108 which provide respective platforms for application programs. In the present embodiment, client application programs (App) 109 are provided on each client computer 102, 103 and a server application program 110 is provided on the server computer 105. The application programs 109, 110 intercommunicate using a messaging system in the form of message-orientated middleware (MOM). Thus, each of the application programs 109, 110 comprises a MOM module 111 for performing the messaging function.

It should be understood that the terms “server” and “client” herein are for exemplary purposes only.

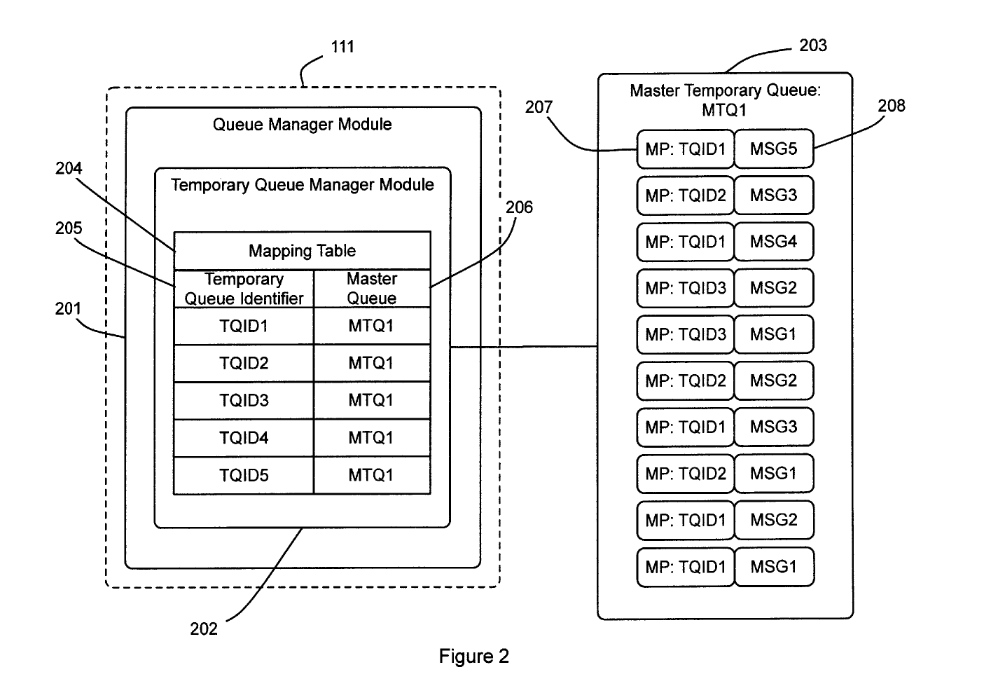

With reference to FIG. 2, in the present embodiment, each MOM module 111 comprises a queue manager module (QMM) 201 arranged to manage one or more queues for storing the messages used by the MOM to provide communications between the application programs 109, 110.

According to the preferred embodiment, the QMM 201 further comprises a temporary queue manager module (TQMM) 202 operable to communicate with the QMM 201.

Typically, a client application program 109 (e.g., residing on client computer 102) generates a request to generate a temporary queue (thus, the request is a request for storage) and sends the request to an MOM module 111 (e.g., residing on client computer 102). In response to receipt of the request, the QMM 201 generates a temporary queue and assigns an identifier to the temporary queue. The client application program 109 determines the temporary queue's identifier and can use the temporary queue's identifier as the location to which it wishes messages to be sent.

In the preferred embodiment however, when a client application program 109 generates a request to generate a temporary queue, the TQMM 202 intercepts the request.

In response to receiving the request, the TQMM 202 suppresses generation of a temporary queue by the QMM 201.

The TQMM 202 generates a unique temporary queue identifier—note that a temporary queue is not generated and that a unique temporary queue identifier is generated.

The TQMM 202 stores the unique temporary queue identifier in a mapping table 204.

In the present embodiment, the TQMM 202 generates or selects a pre-defined queue, termed herein a master temporary queue (MTQ) 203, in order to provide the storage requested by the client application program 109—note that the selected MTQ provides storage rather than a temporary queue.

The TQMM 202 assigns a unique identifier (MTQ1) 206 to the selected MTQ 203; stores the MTQ identifier in the mapping table 204 and maps the unique temporary queue identifier to the MTQ identifier 206 in the mapping table 204.

It should be understood that an MTQ 203 can be associated with a plurality of unique temporary queue identifiers. Thus, an MTQ 203 can effectively provide storage rather than a plurality of temporary queues.

The client application program 109 which generated the request to generate a temporary queue need not know that the temporary queue generation process was suppressed and that storage is provided instead by an MTQ. This will be described in more detail herein.

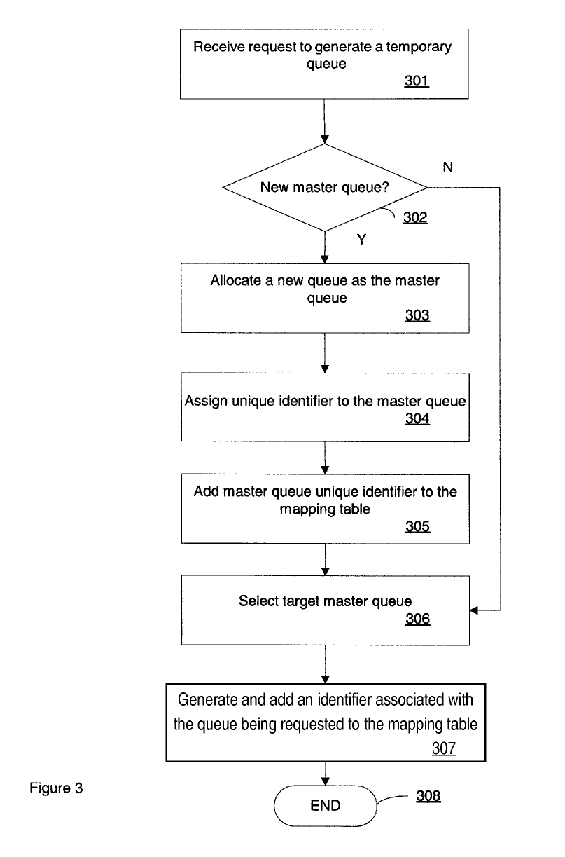

The processing performed by the TQMM 202 in response to receiving a request to generate a temporary queue will now be described further with reference to the flow chart of FIG. 3.

At step 301, processing is initiated in response to the receipt by the TQMM 202 of a request to generate a temporary queue and processing then moves to step 302. At step 302, the TQMM 202 determines whether or not a new MTQ 203 is required to provide storage. For example there may be no currently allocated MTQ or a currently allocated MTQ may not have sufficient capacity to provide storage.

If a new MTQ is required processing moves to step 303. If no new MTQ is required then processing moves to step 306 and proceeds as described herein.

At step 303, a new queue is allocated as the new MTQ and processing moves to step 304. At step 304, a unique identifier is allocated to the new MTQ and processing moves to step 305. At step 305, the new MTQ identifier is added to the mapping table 204 and processing moves to step 306.

At step 306, the TQMM 202 selects a target MTQ 203 to provide storage. In the preferred embodiment, if a new MTQ 203 is required, the new MTQ 203 is selected.

Alternatively, if a new MTQ 203 is not required, preferably the TQMM 202 is arranged to select a MTQ having sufficient storage capacity.

In response to selecting an MTQ, processing moves to step 307 where the TQMM 202 generates a unique temporary queue identifier.

The TQMM 202 adds the unique temporary queue identifier to the mapping table 204 and maps the unique temporary queue identifier to the MTQ identifier associated with the selected MTQ. Processing then ends at step 308.

Advantageously, the selected MTQ provides storage rather than a temporary queue needing to be generated in order to provide storage.

Preferably, the TQMM 202 subsequently passes control to the QMM 201 which sends the unique temporary queue identifier to the client application program 109. The client application program 109 can use the unique temporary queue identifier in subsequent calls and advantageously, the client application program 109 can operate as if there were a temporary queue.

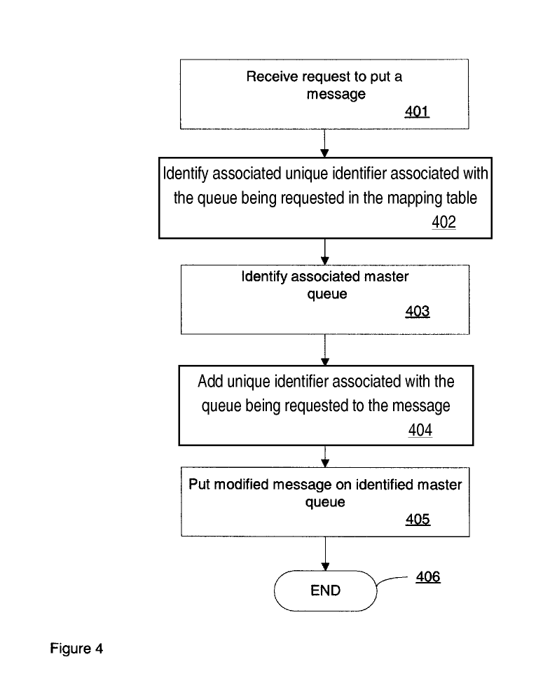

The processing performed by the TQMM 202 in response to receiving a request from the client application program 109 to put a message on a temporary queue will now be described further with reference to the flow chart of FIG. 4.

Processing is initiated at step 401, in response to interception (by the TQMM 202) of a request to put a message on a temporary queue—the request comprises the unique temporary queue identifier—and processing moves to step 402.

At step 402, the TQMM 202 identifies the unique temporary queue identifier in the request to which the put request relates in the mapping table 204 and processing moves to step 403.

At step 403, the TQMM 202 identifies the MTQ identifier associated with the identified unique temporary queue identifier and processing moves to step 404.

At step 404, the TQMM 202 adds the unique temporary queue identifier as a message property 207 to the message to be put and processing moves to step 405.

Preferably, the TQMM 202 passes control to the QMM 201 which (at step 405), puts the modified message onto the MTQ identified by the MTQ identifier and acknowledges the put to the requestor (the client application program 109). Processing then moves to step 406 and ends.

Advantageously, in order to correctly process the request to put a message on a given temporary queue, each message is associated with a message property. Preferably, the message property comprises the unique temporary queue identifier included in the request. Advantageously, the message property 207 thus identifies the given message on the MTQ 203 as being associated with the unique temporary queue identifier.

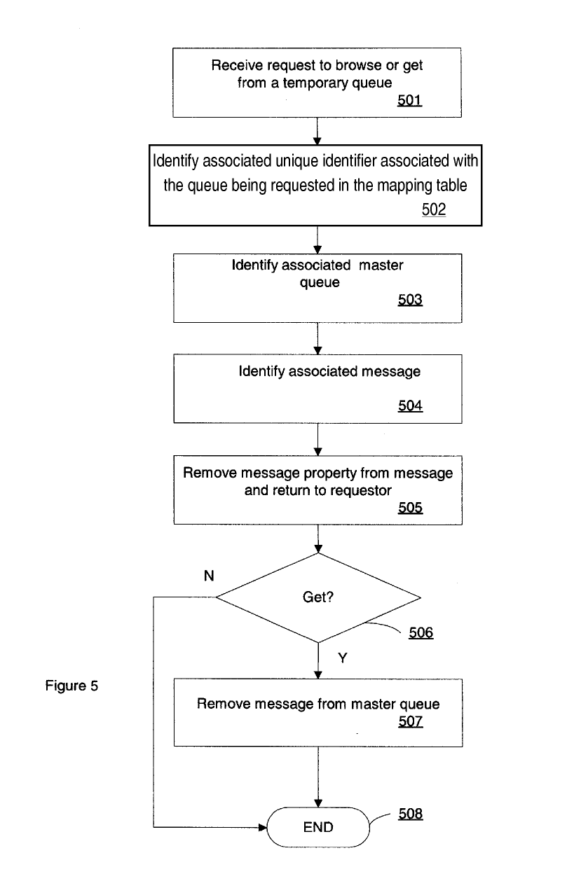

The processing performed by the TQMM 202 in response to receiving a request from the client application program 109 to browse or get a message on a temporary queue will now be described further with reference to the flow chart of FIG. 5.

At step 501, processing is initiated in response to interception (by the TQMM 202) of a request to browse or get a message from a temporary queue—the request comprises the unique temporary queue identifier—and processing moves to step 502.

At step 502, the TQMM 202 identifies the unique temporary queue identifier (in the request) to which the browse or get request relates in the mapping table 204 and processing moves to step 503.

At step 503, the TQMM 202 identifies the MTQ identifier associated with the unique temporary queue identifier in the mapping table 204 and processing moves to step 504.

At step 504, the TQMM 202 accesses MTQ associated with the MTQ identifier and identifies the relevant message on the MTQ using the message property and processing moves to step 505.

At step 505, the TQMM 202 strips the message of the inserted message property and passes control to the QMM 201.

The QMM 201 returns the message to the client application program 109 and processing moves to step 506.

At step 506, if the request comprises a request to get a message, processing moves to step 507. At step 507, the QMM 201 removes the message from the relevant MTQ and processing moves to step 508 and ends.

If at step 506 the request comprises a request to browse a message then processing moves straight to step 508 and ends, leaving the relevant message on the MTQ.

Advantageously, when a request to browse or get a message from a temporary queue is received, the TQMM 202 is arranged to identify the relevant message on the MTQ 203 using the message property 207.

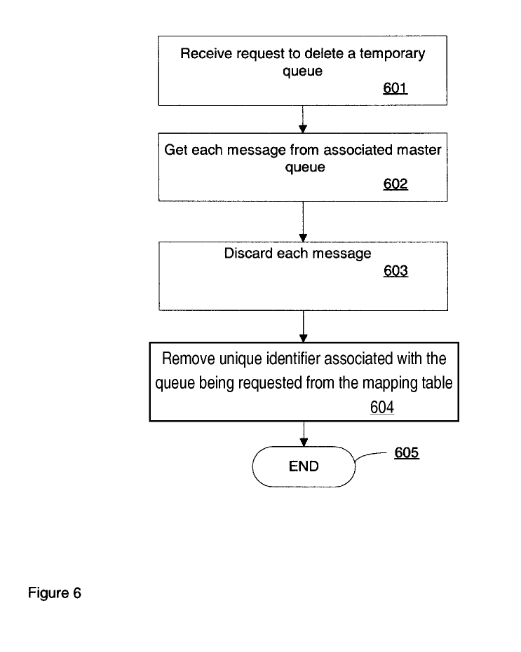

The processing performed by the TQMM 202 in response to receiving a request from the client application program 109 to delete a temporary queue will now be described further with reference to the flow chart of FIG. 6.

At step 601, processing is initiated in response to interception (by the TQMM 202) of a request to delete a temporary queue—the request comprises the unique temporary queue identifier—and processing moves to step 602.

At step 602, the TQMM 202 identifies each message (associated with the unique temporary queue identifier in the request) on the relevant MTQ using the message property and processing moves to step 603.

At step 603, the TQMM 202 retrieves each identified message from the MTQ and discards each retrieved message and processing moves to step 604.

At step 604 the TQMM 202 removes the entry associated with the unique temporary queue identifier from the mapping table 204.

Preferably, the TQMM 202 passes control to the QMM 201 which sends an acknowledgement to the client application program 109 and processing moves to step 605 and ends.

Advantageously, in order to delete a given temporary queue, the TQMM 202 is arranged to remove each relevant message from the MTQ 203 and then to remove the relevant entry associated with the unique temporary queue identifier from the mapping table 204.

Advantageously, the preferred embodiment allows for a client application program to generate a request to generate a temporary queue in a typical manner. However, in a preferred embodiment, generation of a temporary queue is suppressed and a pre-defined queue (wherein the pre-defined queue is effectively “hidden” from the requesting client application program) is used to provide storage instead. Furthermore, advantageously, the requesting client application program can interact with the pre-defined queue as if it were the temporary queue (that is, the requesting client application program need not know that the temporary queue generation process was suppressed and that storage is provided instead by the pre-defined queue). Furthermore, advantageously, the provision of a temporary queue can be “simulated” without requiring the overheads associated with temporary queues e.g., allocating space in pagesets. Furthermore, advantageously, there is a performance improvement if the frequency of e.g., creating or deleting temporary queues is typically high.

Advantageously, the preferred embodiment allows for the TQMM 202 to intercept requests routed between a client application program (which still generates requests in a typical manner) and a MOM 111 (wherein the QMM still manipulates the actual queue)—however, the preferred embodiment allows for the interception to occur with minimal disruption (e.g., as the data in the mapping table is maintained independently of the queue manager module).

In another embodiment, a set of selection criteria is provided for selecting between multiple MTQs to be the target storage provider. For example, a round robin selection system can be used. Alternatively, the MTQ with most free capacity or lowest access frequency can be selected. In a further embodiment, preferably, a single MTQ is selected to provide storage in response to each request to generate a temporary queue.

In another embodiment, the message property is independent of the unique temporary queue identifier. For example, the message property can be a randomly generated term provided by the TQMM on creation of a given unique temporary queue identifier. Alternatively, the message property can be an encrypted version of the unique temporary queue identifier. Having a message property that differs from the unique temporary queue identifier provides a level of security for a MTQ in that an MTQ can only be meaningfully accessed using the TQMM that holds the relevant mapping table.

In a further embodiment, security checks are performed in response to requests from a client application program to create, open or delete a given temporary queue to ensure that requests are generated by an authorized client application program.

It will be understood by those skilled in the art that the apparatus that embodies a part or all of the present invention may be a general purpose device having software arranged to provide a part or all of an embodiment of the invention. The device could be a single device or a group of devices and the software could be a single program or a set of programs. Furthermore, any or all of the software used to implement the invention can be communicated using any suitable transmission or storage means so that the software can be loaded onto one or more devices.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1. A method for managing a request for a message destination, said method comprising:
intercepting a request to create a new temporary destination for a message to a receiving computer;
suppressing generation of the new temporary destination;
selecting a pre-defined destination to store the message instead of the new temporary destination;
assigning an identifier to the new temporary destination being requested; and
associating the identifier with the pre-defined destination.

2. The method of claim 1, further comprising:
transmitting the identifier to a requester that generated the request.

3. The method of claim 1, further comprising:
generating a message property for a message stored on the pre-defined destination, wherein the message property is associated with the identifier such that the message property can be used to identify the message on the pre-defined destination.

4. The method of claim 3, further comprising:
intercepting a store access request from the requestor to store a first message, the store access request comprising the identifier;
generating a first message property for the first message; and
storing the first message on the pre-defined destination.

5. The method of claim 4, further comprising:
intercepting at least one of: a browse access request and a retrieve access request from the requestor to browse the first message and retrieve the first message respectively, the browse access request and the retrieve access request comprising the identifier;
using the first message property associated with the identifier to identify the first message stored on the pre-defined destination; and
returning the first message to the requestor; wherein the first message is an identified first message.

6. The method of claim 5, further comprising:
disassociating the first message property from the first message prior to returning the identified first message to the requestor.

7. The method of claim 5, further comprising:
removing, in response to receiving a retrieve access request, the identified first message from the pre-defined destination.

8. The method of claim 2, further comprising:
intercepting a delete access request from the requestor to delete the temporary destination requested, the delete access request comprising the identifier; and
disassociating the identifier with the pre-defined destination.

9. The method of claim 8, further comprising:
identifying each message stored on the pre-defined destination having a message property associated with the identifier included in the delete access request; and
removing each identified message from the pre-defined destination.

10. The method of claim 1, wherein the pre-defined destination is a message queue on the receiving computer.

11. The method of claim 1, further comprising:
selecting the pre-defined destination from a set of existing pre-defined destinations.

12. The method of claim 11, further comprising:
using a set of selection criteria in order to perform said selecting of the pre-defined destination from the set of existing pre-defined destinations.

13. The method of claim 1, further comprising:
selecting a single pre-defined destination in response to receiving a plurality of requests to generate one or more temporary destinations.

14. A computer system for managing a request associated with a destination being requested in a messaging system, said computer system comprising:
a processor, a computer readable memory, and a computer storage media;
first program instructions to intercept a request to create a new temporary destination for a message;
second program instructions to suppress generation of the new temporary destination;
third program instructions to select a pre-defined destination operable to store the message instead of the new temporary destination;
fourth program instructions to assign an identifier to the new temporary destination associated with the request;
fifth program instructions to associate the identifier with the pre-defined destination; and wherein
said first, second, third, fourth and fifth program instructions are stored on said computer readable storage media for execution by said processor via said computer readable memory.

15. A computer program product for managing a request for a message destination, said computer program product comprising:
a computer readable storage media;
first program instructions to intercept a request to create a new temporary destination for a message to a receiving computer;
second program instructions to suppress generation of the new temporary destination;
third program instructions to select a pre-defined destination operable to store the message instead of the new temporary destination;
fourth program instructions to assign an identifier to the new temporary destination being requested; and
fifth program instructions to associate the identifier with the pre-defined destination; and wherein
said first, second, third, fourth and fifth program instructions are stored on said computer readable storage media.

16. The computer program product of claim 15, further comprising:
sixth program instructions to transmit the identifier to a requester which generated the request, wherein the sixth program instructions are stored on said computer readable storage media.

17. The computer program product of claim 15, further comprising:
sixth program instructions to generate a message property for a message stored on the pre-defined destination, wherein the message property is associated with the identifier such that the message property can be used to identify the message on the pre-defined destination, and wherein the sixth program instructions are stored on said computer readable storage media.

18. The computer program product of claim 17, further comprising:
seventh program instructions to intercept a store access request from the requestor to store a first message, the store access request comprising the identifier;
eighth program instructions to generate a first message property for the first message; and
ninth program instructions to store the first message on the pre-defined destination; and wherein
the seventh, eighth and ninth program instructions are stored on said computer readable storage media.

19. The computer program product of claim 18, further comprising:
tenth program instructions to intercept at least one of: a browse access request and a retrieve access request from the requestor to browse the first message and retrieve the first message respectively, the browse access request and the retrieve access request comprising the identifier;
eleventh program instructions to use the first message property associated with the identifier to identify the first message stored on the pre-defined destination; and
twelfth program instructions to return the identified first message to the requestor; and wherein
the tenth, eleventh and twelfth program instructions are stored on said computer readable storage media.

20. The computer program product of claim 19, further comprising:
thirteenth program instructions to disassociate the first message property from the first message prior to returning the identified first message to the requestor, wherein the thirteenth program instructions are stored on said computer readable storage media.
